(19) United States
(12) Patent Application Publication
(10) Pub. No.: US 2002/0194207 A1
(43) Pub. Date: Dec. 19, 2002

(54) System and method for data synronization between remote devices

(76) Inventors: Troy L. Bartlett, Dacula, GA (US); Kenneth N. Haigh, Lawrenceville, GA (US); Bernard K. Henry, Alpharetta, GA (US); Bret A. Johnson, Alpharetta, GA (US); John W. Kish, Roswell, GA (US); Gregory A. Wandrick, Atlanta, GA (US); David A. Wittler, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/037,626

(22) Filed: Jan. 3, 2002

Related U.S. Application Data
(60) Provisional application No. 60/259,528, filed on Jan. 3, 2001.

(51) Int. Cl. G06F 17/30

(52) U.S. Cl. 707/203

(57) ABSTRACT

The present invention provides a system and method for providing remote device data synchronization. In architecture, the system includes a remote device with a device data, a server device containing an original data and a revision data of the original data, and a delta data that identifies only the changes between the original data and the revision data. The present invention can also be viewed as a method for transmitting data that is modified on a server to a remote device. The method operates by (1) providing an original data; (2) creating update data of the original data; and (3) generating a delta data that identifies only the changes between the original data and the updated data; and (4) transmitting the delta data to a remote device.

### CROSS-REFERENCE TO RELATED APPLICATIONS

This application claims the benefit of U.S. Provisional Patent Application Serial No. 60/259,528, filed on Jan. 3, 2001, and entitled “READYSYNCGO”, which is incorporated by reference herein in its entirety.

### FIELD OF THE INVENTION

The present invention relates to a method and system for updating files, and more particularly, relates to a method and system for efficiently synchronizing data on remote devices.

### BACKGROUND OF THE INVENTION

In many business environments, a server is used to store data that is pertinent to many employees or remote users of a business. The server is typically accessible by remote computer devices (“clients”) to increase the availability of information to the remote users. By providing files on a server, which may be accessed by remote computer devices, dissemination of information through the company is increased. Remote access to data is more critical in environments where a sales force or many employees operate away from the office. As an example, the remote employees rely on the information to be up-to-date to be informed about inventory changes, pricing data, and company events. Rather than remain connected to the server indefinitely and collect telecommunication charges or tie up phone lines, the remote users only intermittently connect their computers to a server for access to data on the server. In these environments, the remote computer devices typically store the server data locally to support the remote application even when the client is not connected to the server. The intermittent connection is then used to send only changes made by the client application to the server and a pertinent set of changes from the server to the client. This type of remote computer system environment is called an Intermittently Connected (IC) environment. ICs have a wide variety of applications in sales force automation, insurance claim processing, and mobile work forces in general anywhere there are mobile users.

An important communication issue for this type of computer environment is the timely and efficient exchange of information between the clients and the server. The term “data transfer” is often used to describe the process of maintaining data consistency and integrity among server files and client files. There are many synchronization schemes for maintaining consistency. In some known file transfer schemes, various protocols and methods, for example compression to efficiently transfer files, are used.

Thus, heretofore an unaddressed need exists in the industry to address the aforementioned deficiencies in synchronization of data downloaded to a remote computer device quickly and efficiently.

### SUMMARY OF THE INVENTION

The invention provides a system and method for efficiently synchronizing the data downloaded to remote devices. The invention may be conceptualized as a remote device data synchronization system includes a remote device with a device data, and a server device containing an original data and a revision data of the original data, and a delta data that identifies only the changes between the original data and the revision data.

The invention may also be conceptualized as a method for efficiently synchronizing the data downloaded to remote devices, the method comprising the steps of: (1) providing an original data; (2) creating update data of the original data; and (3) generating a delta data that identifies only the changes between the original data and the updated data; and (4) transmitting the delta data to a remote device.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an example of the network environment for a server computer system and the remote devices utilizing the remote device data synchronization system of the present invention.

FIG. 2 is a block diagram illustrating an example of a server utilizing the remote device data synchronization system of the present invention.

FIG. 3 is a block diagram illustrating an example of a remote device utilizing the remote device data synchronization system of the present invention.

FIG. 4 is a flow chart illustrating an example of the process flow of the remote device data synchronization system of the present invention, as shown in FIGS. 1-3.

FIG. 5 is an example of flowchart illustrating the operation of the remote data synchronization system process, as shown in FIGS. 1-3.

FIG. 6 is an example of the flowchart for the process to generate the appointment personalized information that is utilized in the remote device data synchronization system of the present invention, as shown in FIG. 5.

FIG. 7 is an example of the itinerary personalized information process operating with the remote device data synchronization system of the present invention, as shown in FIG. 5.

FIG. 8 is an example of the weather agent operating with the remote device data synchronization system of the present invention, as shown in FIG. 5.

FIG. 9 is an example of flowchart illustrating the itinerary agent operating with the remote device data synchronization system of the present invention, as shown in FIG. 5.

FIGS. 10A through 10C 10A through 10C are flowcharts illustrating the process to synchronize a contact from the remote device data synchronization server to a remote device as utilized in the remote device data synchronization system of the present invention, as shown in FIG. 2-5.

### DETAILED DESCRIPTION OF THE INVENTION

The invention to be described hereafter is applicable to all data transfer systems using a remote device data synchronization system in the present invention to maintain current data on remote devices. While described below with respect to a single computer, the system and method for a remote device data synchronization system is typically implemented in a networked computing arrangement in which a number of computing devices communicate over a local area network (LAN), over a wide area network (WAN), or over a combination of both LAN and WAN.

The remote device data synchronization system of the present invention accomplishes two primary goals: (1) Keeps vital personal information synchronized between a user's personal computing devices; and (2) Delivers information to mobile users that is particularly relevant and personalized while mobile (generally, this is information associated with a particular time and/or place).

Mobile professionals will carry multiple mobile computing devices, all of which have specific usage and connection characteristics, making each device uniquely appropriate for certain mobile usage situations. Given this diversity of devices, an obvious user problem is the synchronization of information of these remote devices. The remote device data synchronization system of the present invention provides universal synchronization of a user's contacts, calendar, to do items and memos across remote devices. These types of information are synchronized to the best capability of the particular device. For example, the remote device data synchronization system of the present invention will support:

Office PC (Outlook, other personal information managers (PIMs), etc.)

Home PC (Outlook, +other PIMs, etc.)

Palm OS devices (native PIM apps, etc.)

Win CE OS devices (Pocket Outlook, etc.)

WAP-based phones (full PIM info, etc.)

Non-WAP phones (SMS support, etc.)

The remote device data synchronization system of the present invention also delivers relevant mobile information to user's devices. Three broad guidelines serve to illustrate the type of information delivered:

Information defined by particular appointments the user has;

Information defined by particular trips the user has;

General information that the user needs whenever, wherever they are.

Calendar-based information, working in conjunction with a user's contact database, drives the intelligent delivery of mobile information. Through wizard-type interfaces for creating appointment and trip entries, a user can specify certain relevant types of time/place information. Based on this information, the remote device data synchronization system of the present invention can assemble and monitor important relevant data from a variety of content providers and deliver it to the user's remote devices. For example, if a user is making a trip to Seattle, beginning a few weeks in advance of the trip, the user's remote device can be delivered information about the weather, flight information, directions, hotel information, car rental information, taxi, etc. After the trip, this Seattle-specific information can be removed from the devices. Likewise, based on appointments in the calendar, users can receive directions, company information, etc. useful in successfully conducting that appointment. All content is intelligently delivered to a user's different devices based on the device capacities and different user configuration settings. Information like stock ticker information and competitive company information can be configured to be synchronized to a user's mobile devices. Alert conditions can be set to monitor relevant items like flight status, stock price, appointment information, daily trip information, etc.

The remote device data synchronization system of the present invention can but is not limited to a tiered architecture (i.e. separate tiers for client, business logic services, and data storage), which provides scalability as well as multiple ways of synchronizing and interacting with the data in the central database. The application can reside on a single server, or on a cluster of servers for scalability and reliability.

Each device either browses the central data store directly, or synchronizes its local data store with the central data store via the remote device data synchronization system of the present invention.

Content is piped in from 3^{rd} party vendors, stored in the central database and formatted by the remote device data synchronization system of the present invention. Content for a particular user is available directly, such as on a Web site, and is also synchronized to the user's devices during the same session as for personal information data, for offline viewing.

To provide the synchronization, software is installed on each synchronized remote device. This software serves to translate and map the superset personal information manager (PIM) format of the server database to the specific format of the specific PIM being synchronized. In addition, the client handles synchronization of content from the server and purging of outdated offline content from the device once it is no longer needed. The client/server communication during the synchronization session can be performed via HTTP to eliminate firewall issues. The remote device data synchronization system of the present invention may also support HTTPS (SSL), for users that synchronize via their ISP or other non-secure connection to the Internet.

The remote device data synchronization system of the present invention includes a repository, such as a central database 12. This repository is can be scalable, such as but not limited to Microsoft SQL Server 7.0. All access to the repository can be performed via a set of data access APIs, which serve to decouple the remote device data synchronization system components and services from the database. This architecture enhances scalability and robustness by controlling and pooling database access, and gives the flexibility to port the repository to other RDBMS platforms without making modifications to core components or services.

The remote device data synchronization system manages user synchronization sessions, reconciling data changes between the device being synchronized and the repository. Each remote client device uses client software written for that device for synchronizing. The function of the client is to interface with the unique data format of the client device including, but not limited to Palm, OS, MS-Outlook, etc., and to communicate data changes with the remote device data synchronization system. This communication can be performed via HTTP or HTTPs (user selectable), so it is secure and does not impact firewall configuration. Because interfacing with device data formats is done without server intervention, addition of personal information managers PIM applications or devices is performed through the creation of a new client—with no changes to the server required.

The WAP and Web Services also connect to the central repository via the data access APIs, allowing users to work directly against the data stored in the central repository. Changes made to the data in the repository while a user is browsing will be queued and sent to all synchronized devices. The wireless application protocol (WAP) services work for users with WAP browsers in their wireless handsets. The remote device data synchronization system does not provide the WAP gateway; this is provided by the user's wireless carrier.

An alerting engine (Notification Services) monitors user calendar data, and when an alert condition is met, an alert is queued and sent to the user. Currently, the remote device data synchronization system provides alerts for appointments and flights, as well as summaries of each day's appointments and itinerary items. Alerts can be sent as email messages via an SMTP server, and are formatted as Short Message Service (SMS) messages. This enables remote device data synchronization system to send alerts to email-addressable wireless phones and pagers, in addition to standard email clients.

The remote device data synchronization system of the present invention also provides automatic updating of client software, if a new version is available at the time a user synchronizes. The server sends down the new software and installs it on client devices as part of the synchronization process; there is no intervention required by the user or by the administrator.

The remote device data synchronization system can employ an n-tier architecture, in which the Data tier (database), Business Logic tier, and Web Server tier to be independently scalable via clustering and load balancing. This allows hardware to be added to only the tiers where it is needed for a given configuration. In addition, it allows for a fairly easy scalability path, as hardware can be added at any time, based on empirical measurements of which tiers appear to be bottlenecking.

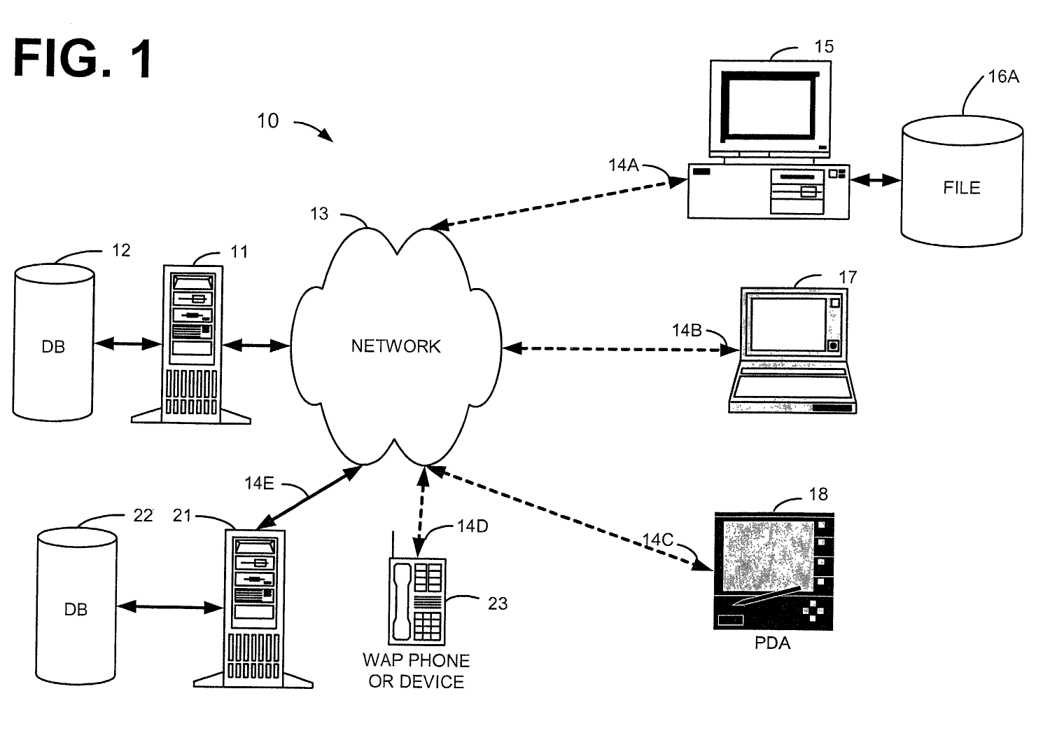

Referring now to the drawings, in which like numerals illustrate like elements throughout the several views, FIG. 1 illustrates the basic components of a system 10 using the remote device data synchronization system used in connection with the preferred embodiment of the present invention. The system 10 includes remote client systems 15, 17, 18 and 23. Each client has applications and can have a local file 16. Computer servers 11 and 21 contain applications and server 11 further contains a server database 12 that is accessed by client systems 15, 17, 18 and 23 via intermittent connections 14(a-d), respectively, over network 13. The server 11 runs administrative software for a computer network and controls access to part or all of the network and its devices. The client systems 15, 17, 18 and 23 share the server data stored on the database 12 and may access the server 11 over a network 13, such as but not limited to: the Internet, a local area network (LAN), a wide area network (WAN), via a telephone line using a modem or other like networks. The server 11 may also be connected to the local area network (LAN) within an organization.

The structure and operation of the remote device data synchronization system 10 enables the server 11 and the database 12 associated therewith to handle clients more efficiently than previously known systems. Particularly, the remote device data synchronization system of the present invention provides a manner of organizing data of the server file into updates that enable a remote client system to update its remote file more efficiently. Periodically, a modification (“delta” or “update”) file is created for each client with all relevant changes since the last modification file creation. When the clients systems 15, 17, 18 and 23 connect to the server 11, the modification files associated with the client are transmitted to the client to be used for updating each client's individual files.

The client systems 15, 17, 18 and 23 may each be located at remote sites. Client systems 15, 17, 18 and 23 include but are not limited to, PCs, workstations, laptops, PDAs, pagers, WAP devices, non-WAP devices, cell phones, palm devices and the like. Thus, when a user at one of the remote client systems 15, 17, 18 and 23 desires to be updated with the current information from the shared file at the server 11, the client system 15, 17, 18 and 23 communicates over the network 13, such as but not limited to WAN, internet, or telephone lines to access the server 11. Advantageously, the present invention provides a system and method for updating client systems to most efficiently transfer their remote files on the server 11. Periodically, the server determines the data that has changed for each client since the last evaluation, and records those changes in a modification file. When a client connects to the server, it requests the modification files for the client, creates the downloaded modification files, and updates its local file.

Third party vendors computer systems 21 and databases 22 can be accessed by the remote device data synchronization system server 11 in order to obtain updated information for dissemination to the remote devices. Data that is obtained from third party vendors computer system 22 and database 23 can be stored on the remote device data synchronization system server 11 in order to provide later access to the user remote devices 15, 17, 18 and 21. It is also contemplated that for certain types of data that the remote user devices 15, 17, 18 and 23 can access the third party vendors data directly using the network 13.

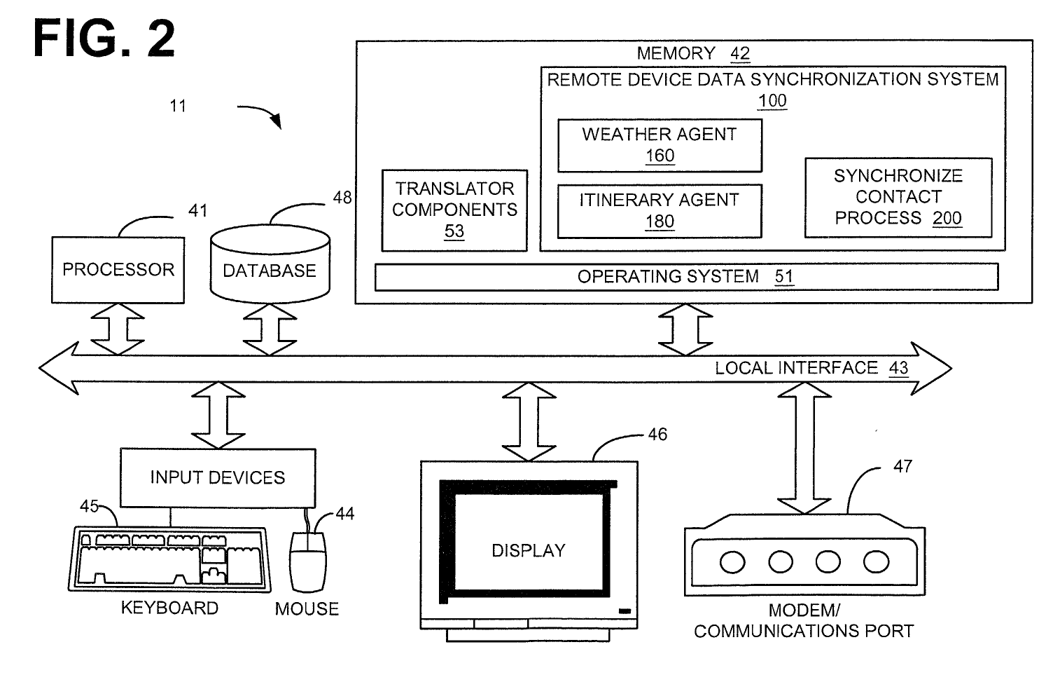

Generally, in terms of hardware architecture, as shown in FIG. 2, the computer and devices 11, 21 and 23 include a processor 41, storage 42 memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU) or an auxiliary processor among several processors associated with the computer 11 and 21, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example of FIG. 2, the software in the memory 42 includes a suitable operating system (O/S) 51 and the remote device data synchronization system 100 of the present invention.

A non-exhaustive list of examples of suitable commercially available operating systems 51 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 51 essentially controls the execution of other computer programs, such as the remote device data synchronization system 100, and provides scheduling, input-output control, file and data management, memory management, and communication control and related services. However, it is contemplated by the inventors that the remote device data synchronization system 100 of the present invention is applicable on all other commercially available operating systems.

The remote device data synchronization system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the remote device data synchronization system 100 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices may include input devices, for example but not limited to, a keyboard 45, mouse 44, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing other files, devices, systems, or a network), a radio frequency (RF) or other transceiver (not shown), a telephonic interface (not shown), a bridge (not shown), a router (not shown), etc.

If the computers 11 and 21 are a PC, workstation, intelligent device or the like, the software in the memory 42 may further include a basic input output system (BIOS) (omitted for simplicity). The BIOS is a set of essential software routines that initialize and test hardware at startup, start the O/S 52, and support the transfer of data among the hardware devices. The BIOS is stored in ROM so that the BIOS can be executed when the computer 11, 15, 16, 18 21 and 23 is activated.

When the computers 11, 15, 16, 18 21 and 23 is in operation, the processor 41 is configured to execute software stored within the memory 42, to communicate data to and from the memory 42, and to generally control operations of the computer 11, 15, 16, 18 21 and 23 pursuant to the software. The remote device data synchronization system 100 and the O/S 52 are read, in whole or in part, by the processor 41, perhaps buffered within the processor 41, and then executed.

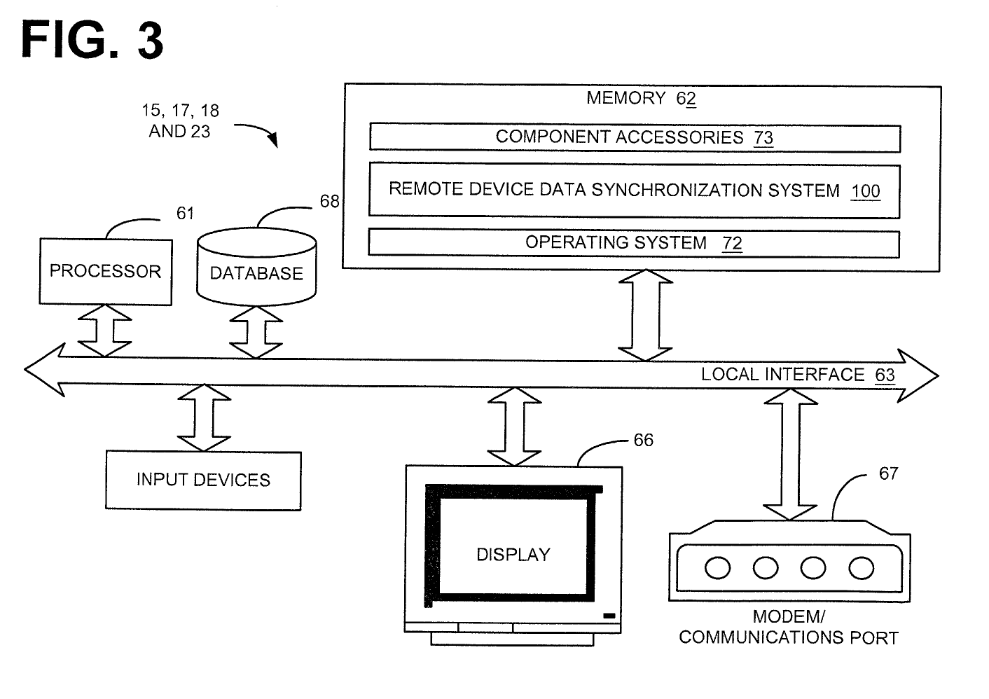

When the remote device data synchronization system 100 is implemented in software, as is shown in FIG. 3A and 3B, it should be noted that the remote device data synchronization system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The remote device data synchronization system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the remote device data synchronization system 100 is implemented in hardware, the remote device data synchronization system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 3B is an example of a remote device utilizing the remote device data synchronization system 100 of the present invention. Remote devices 15, 17, 18 and 23 include, but are not limited to, PCs, workstations, laptops, PDAs, pagers, WAP devices, non-WAP devices, cell phones, palm devices and the like. The components of the remote device 15, 17, 18 and 23 are substantially similar to that of the description for the server 11 (FIG. 2). However, it is contemplated that many of the components in the user's remote device 15, 17, 18 and 23 can be more limited.

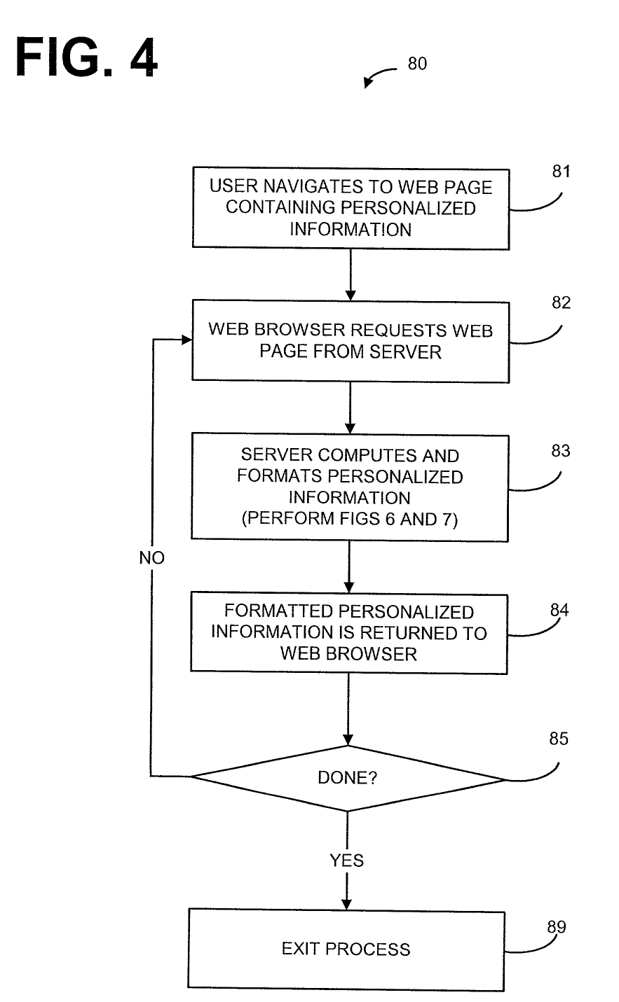

Illustrated in FIG. 4 is an example of a flowchart of the process flow that a user performs in interaction with the remote device and synchronization system 100 of the present invention on server 11. First at step 81, user navigates to a page containing personalized information. This page of information can be accessed using any known network including, but not limited to, a web page.

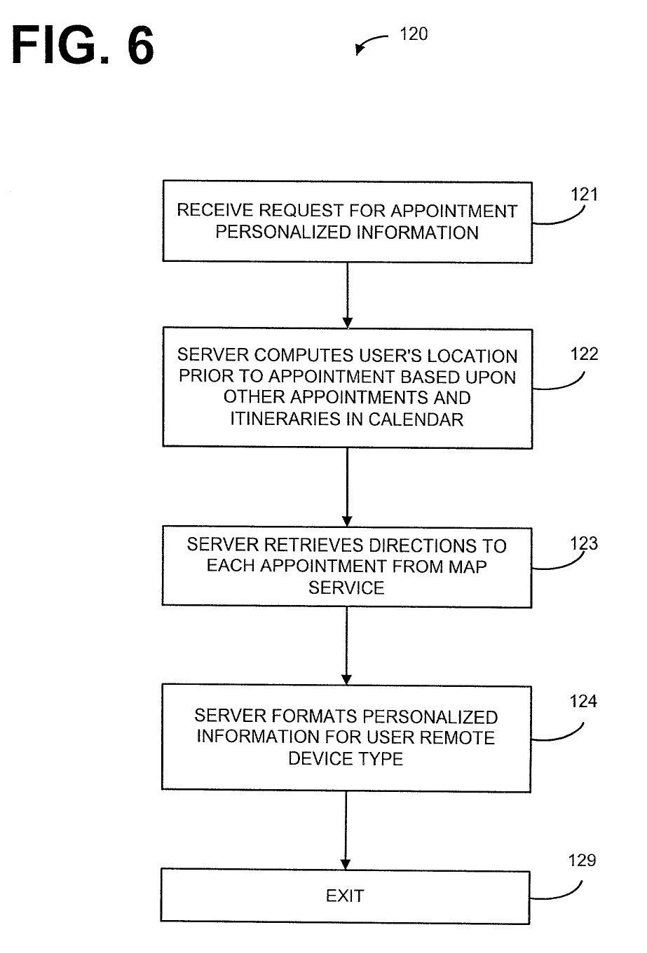

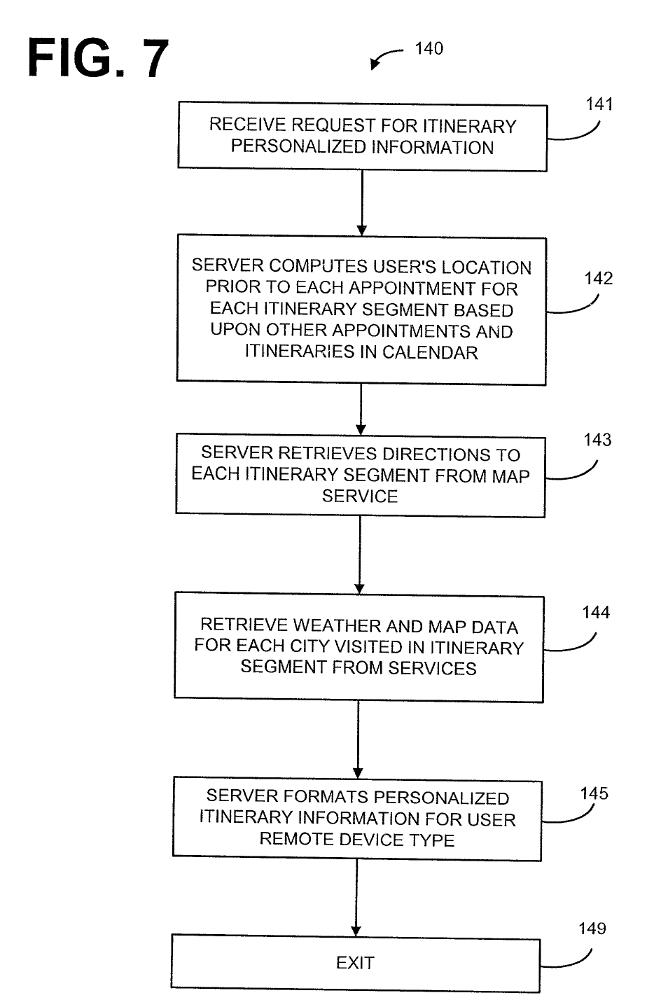

At step 82, the user utilizes the web browser to request a page from the remote device synchronization server 100 of the present invention. At step 83, the remote device due to synchronization server 100 computes and formats the requested personalized information. The flow diagram for computing and formatting the personalized information is herein defined in further detail with regard to FIGS. 6 and 7.

At step 84, the formatted personalized information requested at step 82 is returned to the web browser utilized by the user at step 84. At step 85, the process determines if the user has more personalized information to be requested from the server. If this determines that step 85 that there is no more information to be requested at the user, then the process then exits at step 89. However, if it is determined at step 85 that the user is not done, then the process returns to repeat steps 82 through 85.

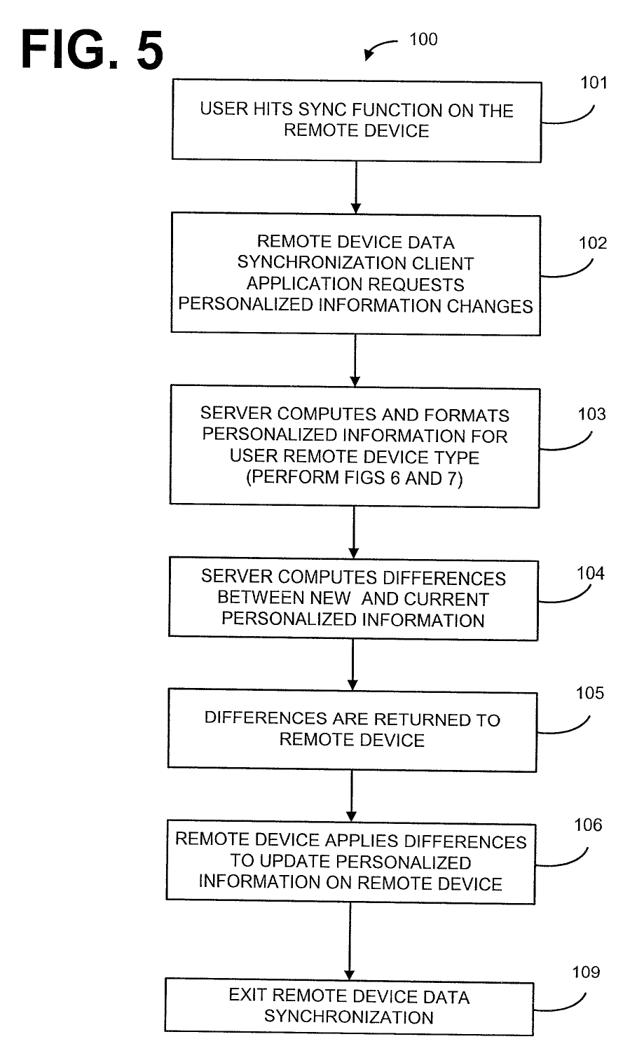

Illustrated in FIG. 5 is an example of flowchart illustrating the operation of the remote data synchronization system process 100. First, the remote device data synchronization 100 is initialized at step 101.

At step 102, the remote device data synchronization system 100 accepts input from the user when the user strikes the synchronization button on the user's remote device. At step 103, the remote device data synchronization system 100 of the present invention requests personalized information changes from the central server 11.

At step 104, the remote device data synchronization server 11 computes and formats personalized information for the device type for present and upcoming appointment and itinerary information. The appointment and itinerary information is herein defined in further detail with regard to FIGS. 6 and 7. At step 105, the server then computes the differences between the new personalized information and the information that is currently residing on the remote user device.

At step 106, the differences are returned to the client to the remote user device for updating the data on the user's remote device. The remote device data synchronization system 100 of the present invention residing on the remote device, then apply the differences and updates the personalized appointment and itinerary information as requested in step 107. The process then exits at step 109.

Illustrated in FIG. 6 is an example of the flowchart for the process to generate the appointment personalized information that is utilized in the remote device data synchronization system 100 of the present invention.

At step 121, the server 11 receives a request for appointment personalized information. At step 122, remote device data synchronization server 11 then calculates the user location prior to the prior appointment based upon either appointments or itineraries within their calendar at step 122.

At step 123, the synchronization server 11 then retrieves the directions for the appointments from a map contents service provider. The map service provider can be for example but is not limited to MapQuest. At step 124, the personalized appointment information is formatted for the appropriate remote device type. The appointment personalized information process 120 then exits at step 129.

Illustrated in FIG. 7 is an example of the itinerary personalized information process 140. First, the personalized itinerary information process 140 receives a request for itinerary personalized information at step 141.

At step 142, the personalized itinerary information process 140 then determines the user's location prior to that segment based upon other appointments and itineraries in the user's component accessories. These component accessories include, but are not limited to, a calendar, scheduler, Outlook, Email or other email based system. At step 143, the personalized itinerary information process 140 then retrieves directions for each of the locations determined at step 142. The directions may be obtained from any type map service including, but not limited to, MapQuest. At step 144, the personalized itinerary information process 140 then retrieves the weather for each city included in the itinerary. This weather data can be obtained from either the synchronization server 11 or centralized database 12 or may be directly requested from a third party vendor 23. Third party vendors include, but are not limited to, Accuweather, Map Quest, the National Weather Service, Weather.com, The Weather Channel, Intellicast, or other like services. At step 145, the personalized itinerary information process 140 then formats the itinerary personalized data in the appropriate format for the user's remote device 15, 17, 18 or 23. Next, the personalized itinerary information process exits at step 149.

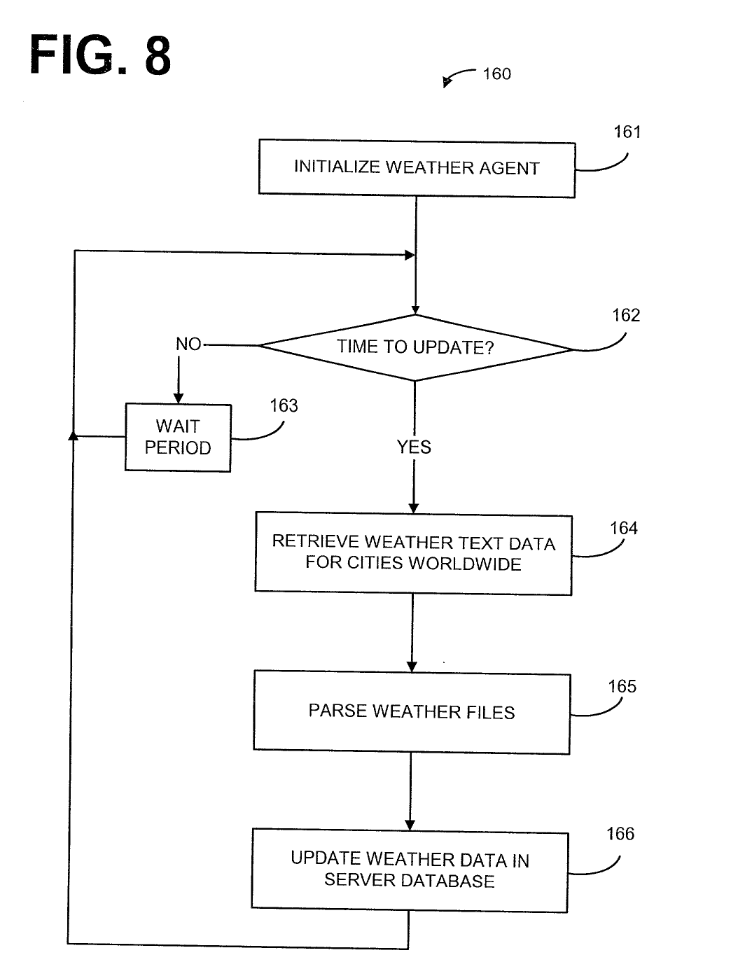

Illustrated in FIG. 8 is an example of the weather agent 160 utilized by the remote device synchronization system 100 of the present invention. First, the weather agent is initialized at step 161. At step 162, the weather agent determines whether it is time for the weather update to occur. This weather update can be a scheduled process or may be on any predetermined time schedule as set by the user and/or the server system administrator. If it is determined at step 162 that it is not yet time for the update, the weather agent then checks whether is time to update the weather conditions for the cities selected in user itineraries. If it is determined in step 161 that it is not time to update the weather itinerary, then the weather agent 162 returns then waits for an appropriate time. Wait time period is executed at step 162. The weather agent then returns to step 162 to check whether it is time for the weather update to occur.

However, if it is determined at step 162 it is time for a weather update to occur, the weather agent then retrieves the weather text files containing the weather data for the thousands of cities worldwide currently being utilized. For example, the weather agent can retrieve text files for worldwide major cities or in an alternative embodiment can scan the itinerary data on database 12 (FIG. 1) to determine which cities currently are in need of updated weather information. After retrieving the weather text at step 164, the weather agent 160 then parses the weather data files in step 165 and updates the weather data in the database 12 (FIG. 1) or later availability to remote users at step 166. The weather agent then returns to step 162 to check it is time for the next weather update to occur.

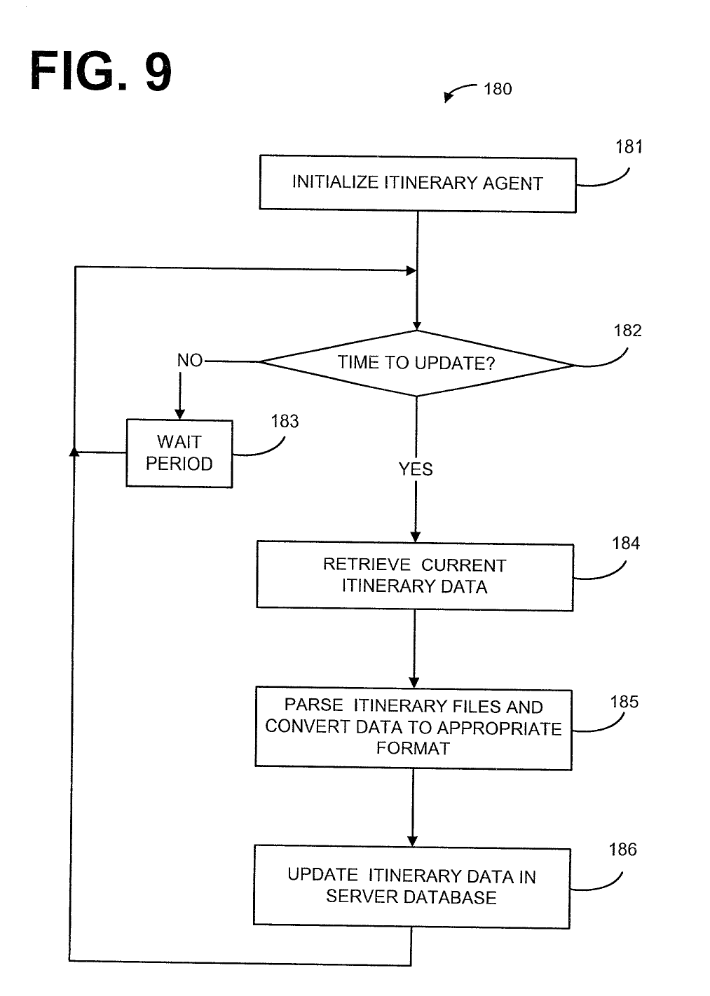

Illustrated in FIG. 9 is an example of flowchart illustrating the itinerary agent 180 utilized in the remote device data synchronization system 100 of the present invention. First, the itinerary agent 180 is initialized at step 181. At step 182, the itinerary agent 180 checks to see if it's time to update the itinerary processes at step 182. If it is determined in step 182 that it is not time to update the itineraries, the itinerary agent 180 then waits a pre-determined period at step 183 before returning to step 182 to check if it's time to update the itineraries.

If it is determined in step 182 that it is time to perform the update of the itineraries then the itinerary agent 180 receives an itinerary in XML format at step 184. At step 185, the itinerary agent 180 processes the itinerary and converts the information into the itinerary agents internal itinerary format.

In step 186, the itinerary agent then updates the itinerary in the remote user's calendar within the remote device data synchronization system database 12 (FIG. 1) for later access by the user. The itinerary agent then returns to repeat steps 182 through 186.

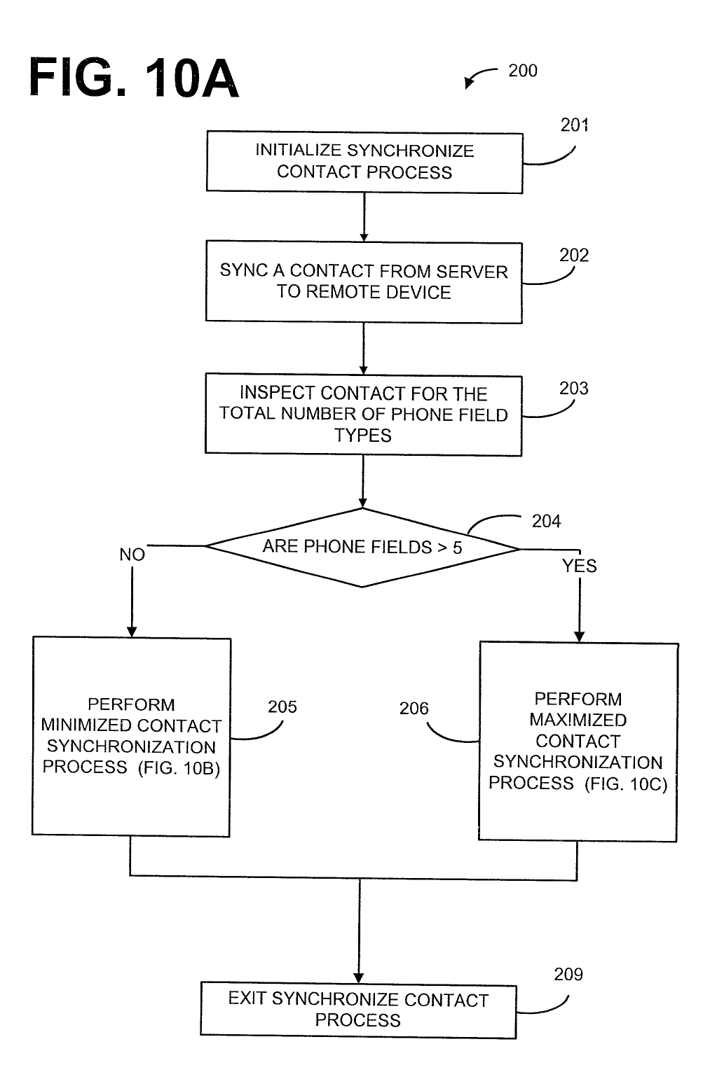

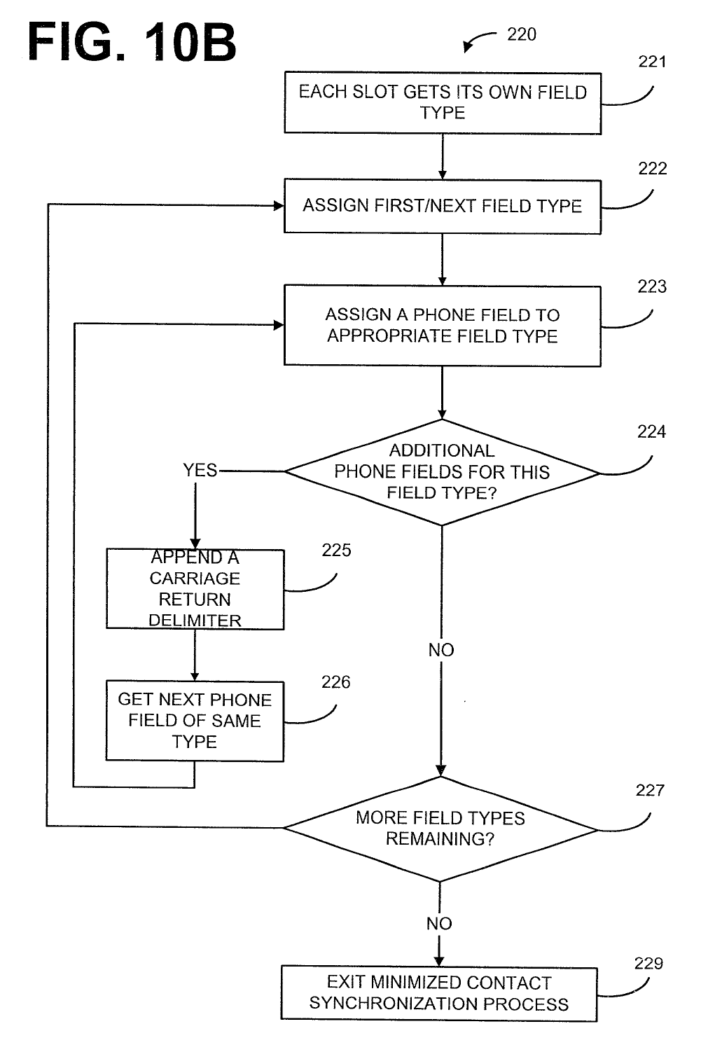

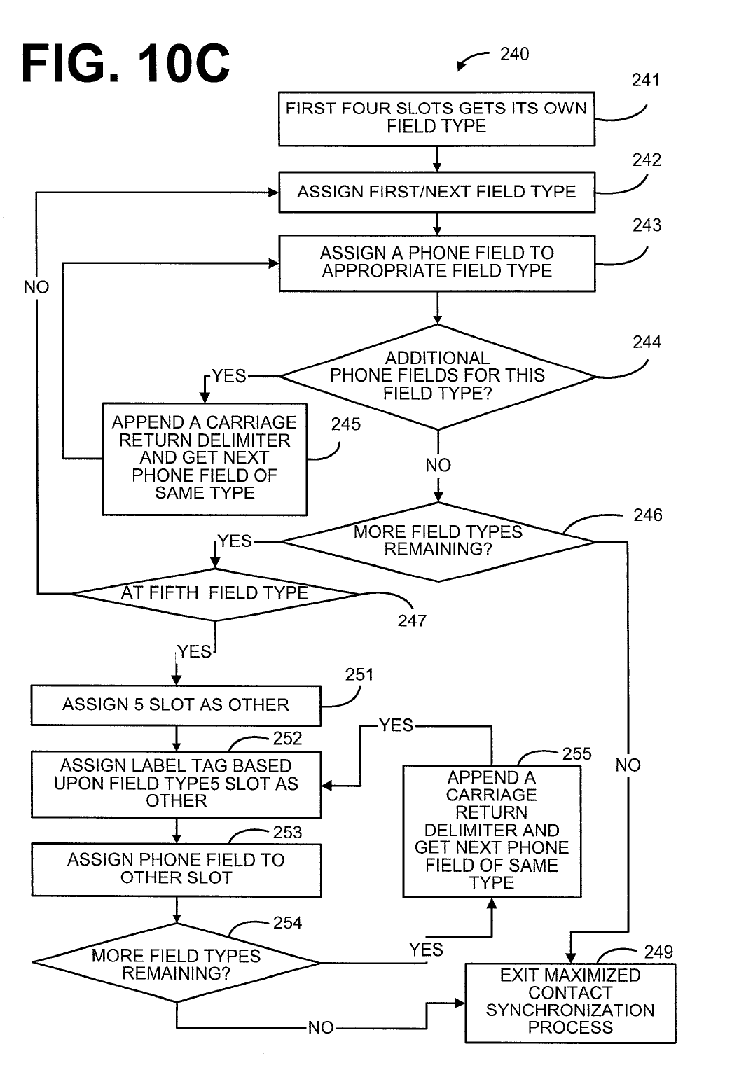

Illustrated in FIGS. 10A through 10C are flowcharts illustrating the process to synchronize a contact from the remote device data synchronization server to a remote device as utilized in the remote device data synchronization system 100 of the present invention.

First in step 201, the remote device data synchronization server 11 synchronizes a contact to a user remote device address book. In step 202, the remote device data synchronization server 11 then inspects the contact with a total number of phone field types at step 203

At step 204, the synchronization server 11 then determines if there are more than 5 phone field types. It is determined in step 204 that there are not more than 5 phone field types then the synchronization contact process 200 then performs the minimized synchronization process to 200 hereindefined in further detail with regard to FIG. 11B. After performing the minimized contact synchronization process 220, the contact synchronization process 200 then exits at step 209.

However, if it's determined at step 204 that there are more than 5 phone field types, then the contact process 200 performs the maximum contact synchronization process 240 that is hereindefined in further detail with regard to FIG. 11C. After performing the maximum contact synchronization process 240, the contact synchronization process 200 then exits to step 209.

Illustrated in figure 10B is the minimal contact synchronization process 220. First, the minimal contact synchronization process 220 acquires a slot for each field type in step 221.

In step 222, the minimized contact synchronization process 220 then assigns for each field type the phone field to the appropriate field type. At step 223, the minimized contact synchronization process 220 then determines if there are additional phone fields for the current field type. If it is determined in step 223 that there are additional phone fields for the current field type, then the minimized contact synchronization process 200 then appends a carriage return to the current field type and at step 223 and the next phone field of the same type at step 225. After getting the next phone field of the same type at step 225, the minimized contact synchronization process 220 then returns to step 222 to assign the next phone field to the appropriate field type.

However, if it is determined that step 223 that there are no more additional phone fields for the current field type then the minimized contact synchronization process 220 then determines if there are any other field types remaining at step 226. It is determined that step 226 that there are other field types remaining then the minimized contact synchronization process 220 then returns to repeat steps 222 through 226. However, if it's determined that step 226 that there are no other field types remaining then the minimized contact synchronization process 220 then exits at step 229.

Illustrated in FIG. 10C, it is an example of the maximized contact synchronization process 240. First, the maximized contact synchronization process assigns the first 4 slots with their own field type at step 241. At step 242, the maximized contact synchronization process 240 then assigns the phone field to the appropriate field type.

At step 243, the maximized contact synchronization process 240 then determines if there are additional phone fields for the current field type. If it is determined that step 243 that there are additional phone fields for the current field type, then the maximized contact synchronization process 240 then perform step 244 to append the carriage return delimiter to the current field type and gets the next phone field of the same type. After appending the carriage return delimiter and getting the next phone field of the same type at step 244 the maximized contact synchronization process 240 then returns to repeat step 242.

However, at step 243 that there are no additional phone fields for the current field type then the maximized contact synchronization process 240 then determines if there are other field types remaining at step 245. If it is determined at step 245 that there are other field types remaining, then the maximized contact synchronization process 240 then determines if the remaining field type is the 5^{th} field type at step 246. If it is determined that step 246 that the next field type is not the 5^{th} field type, then the maximized contact synchronization process 240 then returns to repeat step 242. However, if it is determined that step 246 that the next field type is the 5^{th} field type, then the maximized contact synchronization process 240 assign the 5^{th} slot as other at step 251.

At step 252, the label tag based upon the field type of the current slot. At step 253, the maximized contact synchronization process 240 assigns the phone field to the “other” slot and determines that step 254 if there are other remaining phone fields to be processed. If it is determined that step 254 that there are other phone fields remaining, then the maximized contact synchronization process 240 then appends a carriage return delimiter and gets the next phone field at step 255. The maximized contact synchronization process 240 then returns to repeat steps 252 through 254.

However, if it is determined that step 254 that there are no other field types remaining, then the maximized contact synchronization process 240 then exits at step 259.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A method for transmitting data that is modified on a server to a remote device, comprising the steps of:
providing an original data;
creating updated data of the original data;
generating a delta data that identifies only the changes between the original data and the updated data; and
transmitting the delta data to a remote device.

2. The method of claim 1, wherein said step of generating delta data further comprises the step of:
creating a binary tree to identify the changes between the original data and the updated data.

3. The method of claim 1, wherein the generating delta data step further comprises:
using a personalized data to generate the delta data, wherein the personalized data is selected from the group consisting of appointment data, itinerary data, map data, weather data, calendar data, flight data, hotel data, taxi data, rental car data and contact data.

4. The method of claim 3, wherein said contact data includes telephone data.

5. The method of claim 4, further comprising the step of:
recreating the updated data on the remote device using only the delta data and a device original data.

6. A system for transmitting data that is modified on a server device to a remote device, comprising:
a remote device with device data;
a server device containing an original data and a revision data of the original data; and
a delta data that identifies only the changes between the original data and the revision data.

7. The system of claim 6, wherein the remote device further comprises:
a synchronization module that create the revision data on the remote device using the delta data and the device data.

8. The system of claim 6, wherein the server device further comprises:
a transmission module that transmits the delta data to the remote device so the remote device can recreate the revision data.

9. The system of claim 6, wherein the server device further comprises:
a compare module that compares each block of data in the original data with each block of data in the revision data.

10. The system of claim 6, wherein the compare module compares personalized data to generate the delta data, wherein the personalized data is selected from the group consisting of appointment data, itinerary data, map data, weather data, calendar data, flight data, hotel data, taxi data, rental car data and contact data.

11. A computer readable medium for a logic that transmits data that is modified on a server to a remote device, comprising:
logic for providing an original data;
logic for creating updated data of the original data;
logic for generating a delta data that identifies only the changes between the original data and the updated data; and
logic for transmitting the delta data to a remote device.

12. The computer readable medium of claim 11, wherein the logic for generating further comprises:
logic for creating a binary tree to identify the changes between the original data and the update data.

13. The computer readable medium of claim 11, wherein the generating logic uses personalized data to generate the delta data, wherein the personalized data is selected from the group consisting of appointment data, itinerary data, map data, weather data, calendar data, flight data, hotel data, taxi data, rental car data and contact data.

14. The computer readable medium of claim 13, wherein said contact data includes telephone data.

15. The computer readable medium of claim 11, wherein the logic for generating further comprises:
logic for recreating the updated data on the remote device using only the delta data and data on the remote device.

16. A system for transmitting data that is modified on a server to a remote device, comprising:
means for providing an original data;
means for creating updated data of the original data;
means for generating a delta data that identifies only the changes between the original data and the updated data; and
means for transmitting the delta data to a remote device.

17. The system of claim 16, further comprises:
means for creating a binary tree to identify the changes between the original data and the update data.

18. The system of claim 16, wherein the generating means uses personalized data to generate the delta data, wherein the personalized data is selected from the group consisting of appointment data, itinerary data, map data, weather data, calendar data, flight data, hotel data, taxi data, rental car data and contact data.

19. The system of claim 18, wherein said contact data includes telephone data.

20. The system of claim 16, further comprises:
means for recreating the updated data on the remote device using only the delta data and data on the remote device.
